(19) United States
(12) Patent Application Publication
(10) Pub. No.: US 2016/0280372 A1
(43) Pub. Date: Sep. 29, 2016

(54) CRANED AIR TRANSPORTER

(71) Applicant: NOLAN RUSSELL PONESS, Pittsburgh, PA (US)

(72) Inventor: NOLAN RUSSELL PONESS, Pittsburgh, PA (US)

(73) Assignee: NOLAN RUSSELL PONESS, Canonsburg, PA (US)

(21) Appl. No.: 14/668,876

(22) Filed: Mar. 25, 2015

(51) Int. Cl. B64D 9/00; B60P 3/32; B60R 9/055; B64D 1/22

(52) U.S. Cl. CPC B64D 9/00; B64D 1/22; B60P 3/32; B60R 9/055

(57) ABSTRACT

A multi-purpose craned air transporter (CAT) that is structurally configured to manage liabilities, and to expedite independent functions for hauling and craning operations. The CAT assembly is multi-purpose for ground and air operations with the necessary attachments to execute each specified operation. The CAT is configured with a top mount for interoperability with a craning device, which shall be attached to a crane or helicopter. The CAT also has a bottom mount to operate with ground transportation. The CAT assembly shall be designed to detach from the confines of a crane, helicopter, or article of ground transportation that may be in control of the assembly to execute a specific operation. The CAT assembly includes altered embodiments to facilitate several different operatives that may require a customized module to achieve maximum effectiveness.

### PRIOR PUBLICATION DATA

| | |
|---|---|
| US 2014/61967723 A1 | MARCH 25, 2014 |
| US 2014/61998506 A1 | JUNE 30, 2014 |
| US 2014/61999107 A1 | JULY 16, 2014 |

### REFERENCES CITED

| | | |
|---|---|---|
| 3,997,135 | December 1976 | Peterson |
| 4,238,095 | December 1980 | Slater |
| 4,378,919 | April 1983 | Smith |
| 8,157,205 | April 2012 | McWhirk |

### NON-PATENT LITERATURE DOCUMENTS

Poness, Nolan, “Saving Minutes When Seconds Count” (June 2014)

### PARENT CASE TEXT

This application claims the benefit of provisional patent applications Ser. No. 61/967,723, filed 2014 Mar. 25, Ser. No. 61/998,506, filed 2014 Jun. 30, and Ser. No. 61/999,107, filed 2014 Jul. 16 by the present inventor.

### FIELD OF THE INVENTION

This invention relates to a structure generally utilized through hauling and craning operations.

### BACKGROUND

It has shown to be the case that single-engine aircraft and multi-engine aircraft have a similar purpose. The purpose is to transport passengers and cargo to a desired destination at a faster rate than any other means of transportation. Multi-engine aircraft attract passengers who have the financial capability of flying, but do not want to participate in a less convenient means of single-engine flying. The passengers can be described as having the need for a method of transportation that does not require them to participate in the rigors of the transport process. Airplanes are generally used when commuting long distances.

On the contrary, helicopters emphasize the need for short haul transportation. Helicopters allow passengers to travel shorter distances at a faster rate than any other means of transportation in its category. The faster rate of travel is due to the ability to fly direct as opposed to following roads and railways. The problems that exist with helicopter flight are in direct correlation with the opposition between multi-engine and single-engine aircraft. Helicopters are expensive to operate, and most individuals have to hire a pilot unless they have a license to operate one. Also, they can be considered dangerous at times when loading, which can be unattractive to the public. A few types of supplemental articles of manufacture have been proposed as a portable module to help combat these deficiencies, for example, in U.S. Pat. No. 4,238,095 (1980). This invention has relevant characteristics and advantages to welcome the use of alternative air travel, despite not attached to a helicopter, but the module is permanently attached to the airship, which creates a complex departure and arrival process. Also, this invention seemingly requires a docking station, which may increase cost and take up too much of an area. In U.S. Pat. No. 3,997,135 (1976) the invention brings forth the right idea, but lacks any means for reduced manual interaction. This particular design most likely extends hovering rates, which may increase stress on the pilot. Also, this invention requires crewmembers on the ground to help direct and detach the module, which delays departure and arrival procedures. The prior art serves a purpose and may be useful in certain scenarios, but sacrifices efficiency and economic reassurance that an investment in this technology will provide a reasonable return from consumer targeted transportation technology.

Another important factor to understand is the role that taxi and bus services have played in our economy. For example, passengers have opted to purchase seats in a taxi or bus not only for convenience, but also for the desire to retain the time otherwise spent operating a vehicle. Passengers have been able to make use of this time retained by taking a taxi or a bus. Also, if the passengers will commute to highly congested areas, then the passengers are able to commute without any concern for locating a parking spot.

Passengers of taxi and bus transportation methods are susceptible to traffic delays, accidents, and construction. Also, these methods of transportation are susceptible to diversions in roadways due to mountains, lakes, and any other obstacle causing a road to unfortunately have no direct passage.

Thus, to overcome the shortcomings of the prior art, it shall be the case; multi-engine passengers alike will require a convenient means of pre-emptive transportation. Also, helicopter, taxi, and bus passengers alike shall desire the most convenient means of access to short haul public transportation.

### SUMMARY OF THE INVENTION

In order to solve the problems and shortcomings of the prior art, according to one preferred embodiment an object of the present invention is to provide a multi-purpose craned air transporter (CAT) that is structurally configured to execute independent functions, which shall utilize the advantages claimed by the design of the craned air transporter.

Another object of the present invention is to provide a mount assembly to interact with an article of ground transportation with the design of the craned air transporter for independent ground operations.

Still another object of the present invention is to provide a mount assembly to interact with a craning device for independent air or crane operations.

These and other objects are achieved by a multi-purpose craned air transporter (CAT) according to the present invention, and the characteristics that accompany the invention for all of its intended purposes.

In accordance with another embodiment, an object of the present invention that will have a buoyancy factor is to utilize those advantages created by the multi-purpose craned air transporter in order to operate in aquatic rescue missions as a means for expediting and increasing the success rate of saving lives by attaching the embodiment to a rescue helicopter in whatever weather conditions that may exist.

The particular purpose of these aspects is to address the disadvantages that are affiliated with the field of the invention, but will not be limited to said field. The problem to be addressed is the current inefficient transportation of cargo and people. The several advantages of one or more aspects are to create a more efficient system of short haul transportation.

### BRIEF DESCRIPTION OF THE DRAWINGS

FIG. 1 is a side view of the embodiment, which is shown with a rounded fuselage.

FIG. 2 is a top view of the embodiment, which shows an entrance and exit hatch, and a mount that permits an attachment to a craning device.

FIG. 3 is a front view of the embodiment, which is shown with the rounded fuselage and a rectangular bottom with a lock receiver configured underneath.

FIG. 4 is an illustration of an isometric view of the embodiment, which shows a top door and mount.

FIG. 5 is an illustration of an isometric view of a rectangular embodiment, which shows a normal access door and emergency access door.

FIG. 6 is a rear view of a rectangular embodiment, which shows a lock receiver underneath.

FIG. 7 is a side view of a rectangular embodiment, which shows a normal access door.

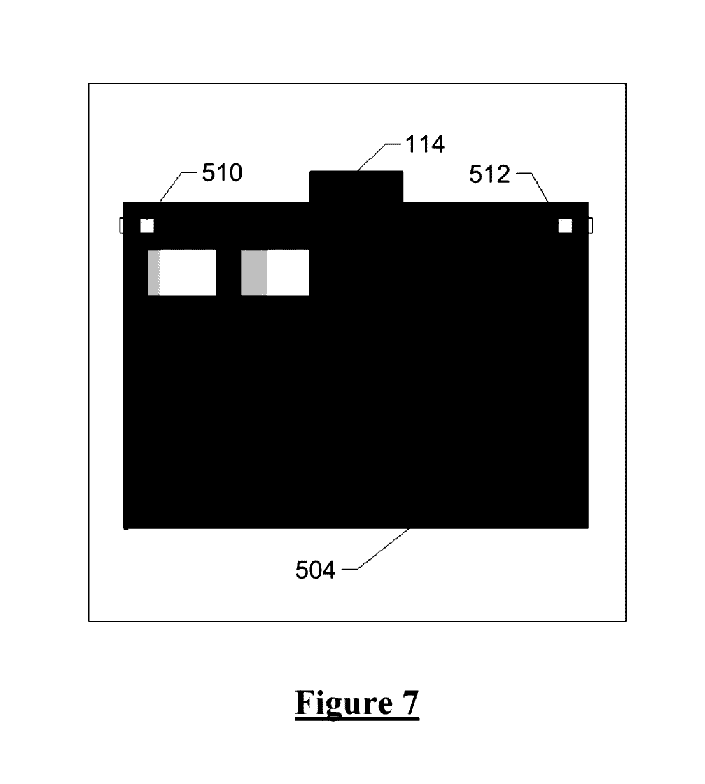

FIG. 8 shows a base mount and lock receiver area underneath of the embodiment.

FIG. 9 is a sectional side view of a mount showing the internal composition to interact with locking functions.

FIG. 10 is a sectional isometric view of a mount showing the particular placement to receive a locking device.

### DETAILED DESCRIPTION OF THE PREFERRED EMBODIMENTS

This disclosure identifies the preferred embodiment to be described as a craned air transporter 100. This description is for understanding how the embodiment is configured and how it may operate. The preferred embodiment will not be limited to such description.

To achieve the desired performance, the embodiment is constructed in a manner that reflects a best composition of weight and structure coherence. Coherence is achieved by means of a composite lightweight frame that has specified industry standards. The craned air transporter 100 is covered by a durable lightweight skin material similar to the skin of an aircraft, but shall not be limited to said material. The craned air transporter 100 is designed with the intent to reduce drag as much as possible. All protruding parts, such as rivets, are flush with the skin of the embodiment to reduce parasite drag. Also, lights, handles, and all other parts of the embodiment that might cause parasite drag while in flight are designed with the intent to reduce drag.

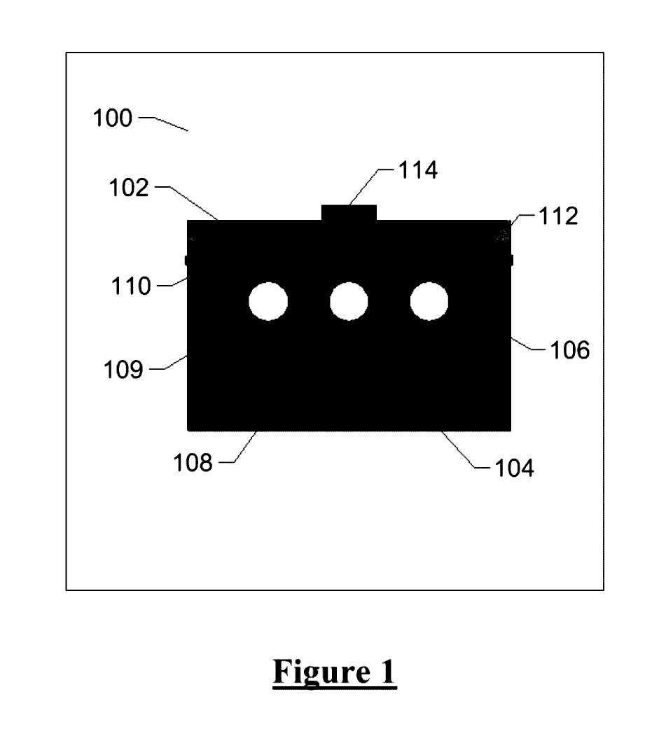

FIG. 1 is one version of a craned air transporter 100. FIG. 1 is a side perspective of the craned air transporter 100. Fuselage 102 is the main body and it is configured as a round body for buoyancy and aerodynamic factors. Underneath the fuselage 102 is a bottom mount 104. A roof mount 114 is shown positioned on top of the embodiment. The mount 114 is comprised of a magnetic assembly on this particular embodiment, but it shall not be limited to said assembly. The mount 114 is welded to the frame on this particular embodiment, and fastened by frame supports. The craned air transporter 100 has sidelights 110, 112. Sidelights 110, 112 are bolted on and waterproof sealed on this particular embodiment. There are windows 106, 108, 109. Windows 106, 108, 109 are solid panel with no access. The windows 106, 108, 109 are waterproof sealed on this particular embodiment.

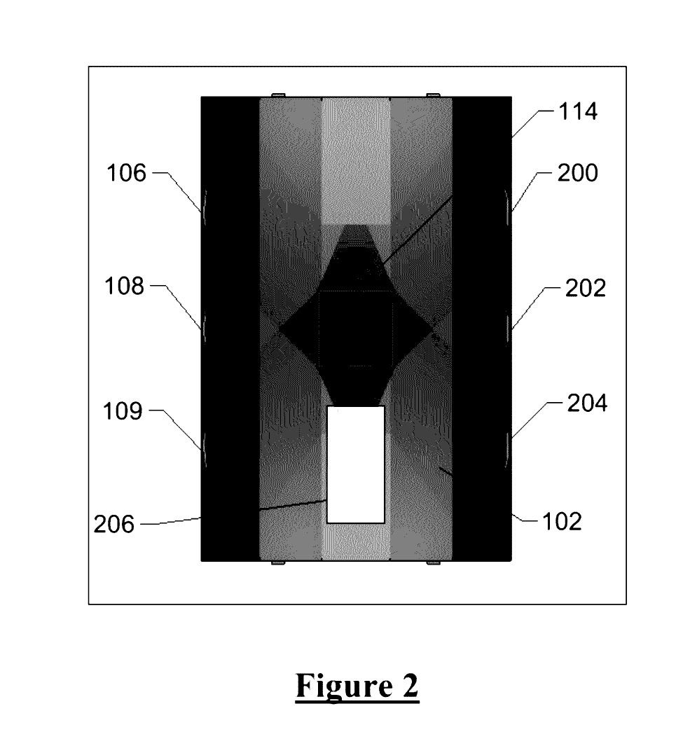

FIG. 2 shows the embodiment from a top perspective. The mount 114 is shown fastened by said means heretofore (FIG. 1) on top of the craned air transporter 100 ceiling. All of the windows 106, 108, 109, 200, 202, 204 are solid panel and waterproof sealed.

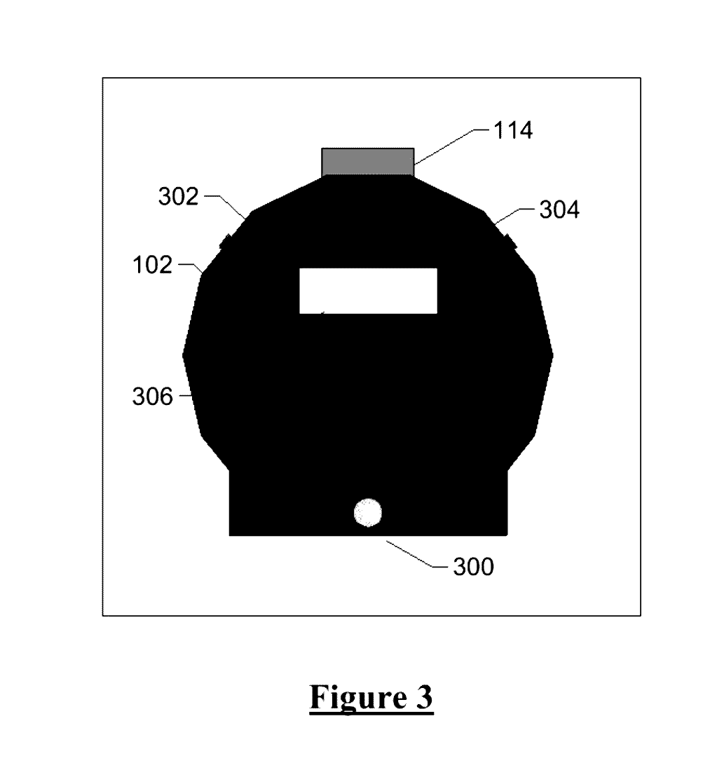

FIG. 3 shows a front perspective. There are front lights 302, 304 on either side near the top of the craned air transporter 100. Lights 302, 304 are fastened by said means heretofore (FIG. 1) 110, 112. There is rear window 306 below the lights 302, 304. The rear window 306 is solid panel and waterproof sealed on this embodiment. Base mount 300 is shown as the female assembly constructed with high yield strength material to withstand the forces applied by a lock device and integrated support members. Base mount 300 receives a powered lock device to secure the module to an article of ground transportation.

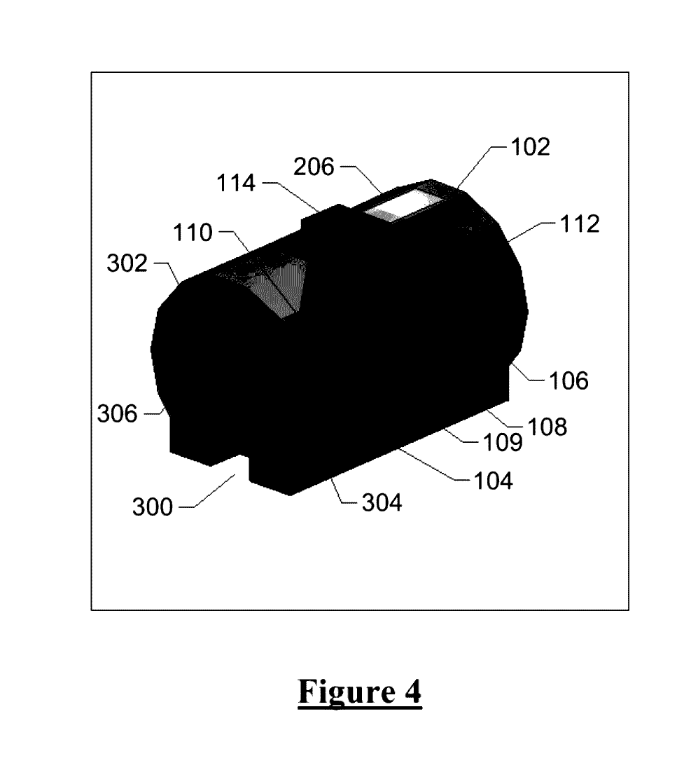

FIG. 4 shows an isometric perspective. The mount 114 is shown fastened by said means heretofore (FIG. 1) on top of the craned air transporter 100. Sidelights 110, 112 are on either side near the top of the craned air transporter 100. Below the sidelights 110, 112 are windows 106, 108, 109. The windows 106, 108, 109 are solid panel and waterproof sealed.

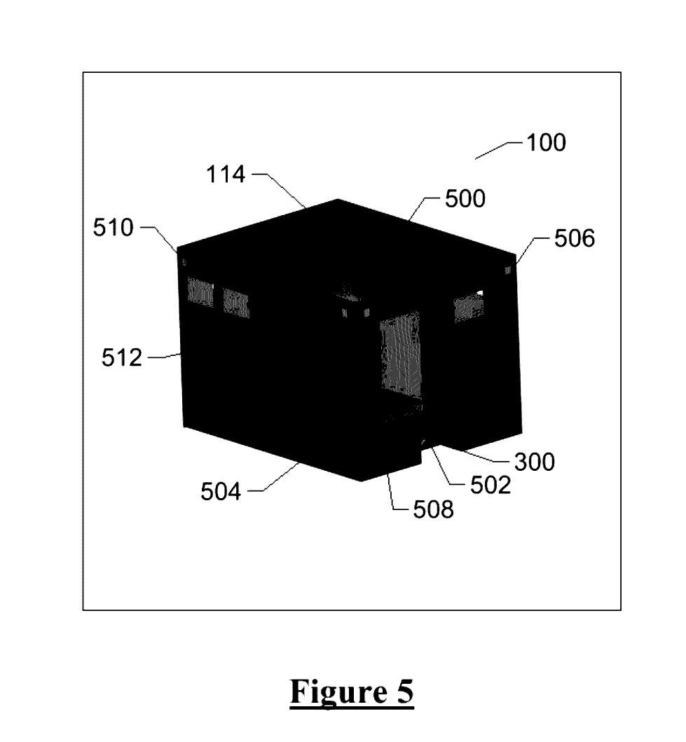

FIG. 5 is an isometric view of another embodiment with a rectangular fuselage 500. The craned air transporter 100 has a door 504. The door 504 is waterproof sealed on this particular embodiment, and hinged by means of durable brackets and pins. The door 504 may be connected to sensors inside. Lights 506, 508, 510, 512 are mounted and waterproof sealed on the sides of the fuselage.

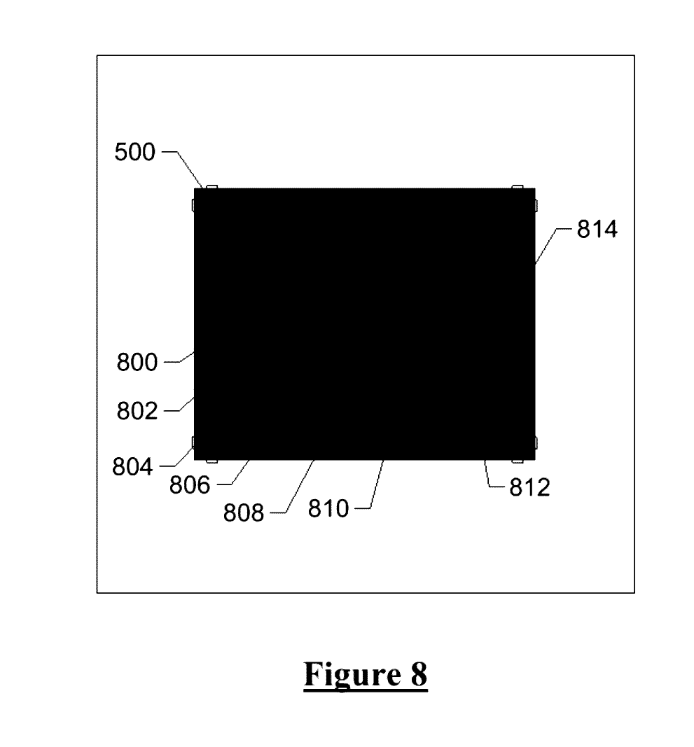

FIG. 8 shows a bottom perspective of the craned air transporter 100. The bottom of the fuselage 500, 102 (FIG. 3) shows divided base mount 300 with lock receivers 800, 802, 804, 806, 808, 810, 812, 814. Base mount 300 is individually constructed with high yield strength material to withstand forces applied to the receiver area and the support members.

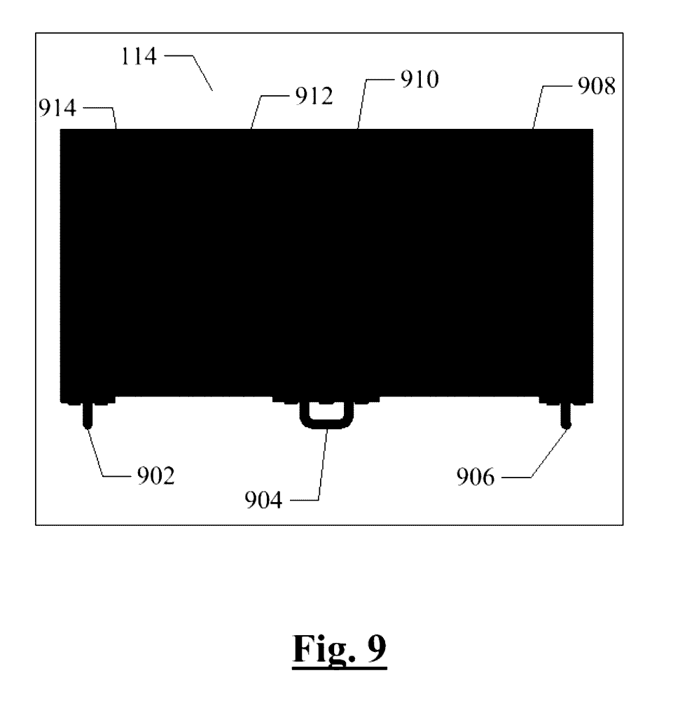

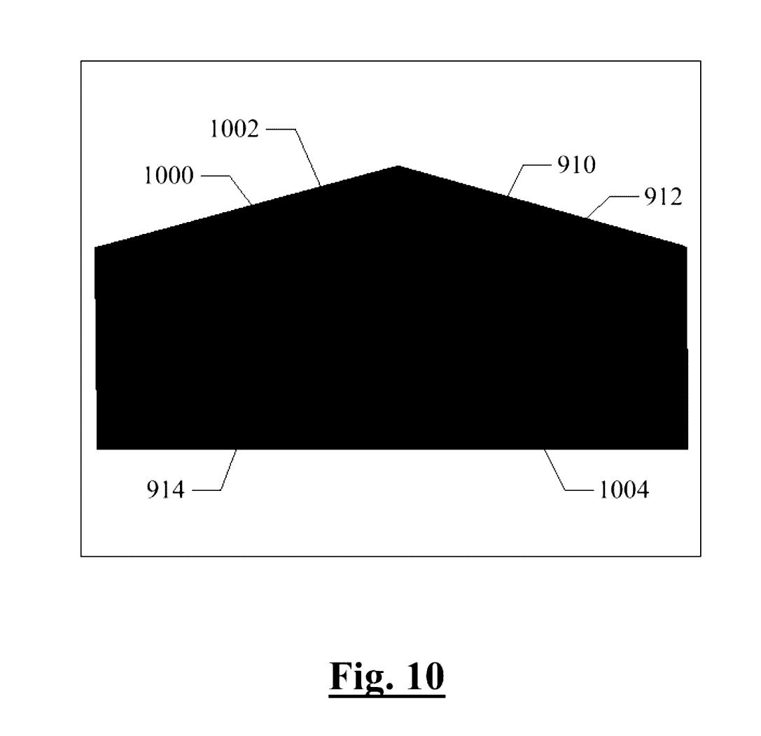

The mount to be placed on top of the craned air transporter 100 is shown in FIG. 9 and FIG. 10. The mount 114 (FIG. 9) is shown in a sectional configuration. The mount 114 is shown to be symmetric about all central axes. Supports 902, 904, 906 (FIG. 9) are bolted underneath the bottom of the mount 114, which shall fasten said mount 114 to fuselage 102 (FIG. 2), 500 (FIG. 5). The view shows anchor beam 908, 914 encompassed by the hollow shrouding. The shrouding shall be composed of a lightweight material that is durable and can withstand the forces from above that are applied while in operation. Each anchor beam 908, 914 shall be formed with high yield strength material to withstand forces for a reliable connection. Also, shaft 910 (FIG. 10) and magnetic guide lining 912 (FIG. 10) is shown on the exterior of the shrouding, but inside the concaved portion of the mount 114.

The goal of the preferred embodiment is to utilize its advantages in order to achieve a more efficient method of transportation and to create the means for pre-emptive loading method. In regards to transporting passengers and cargo, the round embodiment (FIG. 4) is the most efficient model for said utilization due to aerodynamic and buoyancy factors considered. Mount 114 is positioned on the roof of the craned air transporter 100 (FIG. 1). The purpose of the mount 114 is to receive and secure a connection to a craning device that will lift and hold the craned air transporter 100 (FIG. 1). The craned air transporter 100 has sidelights 110, 112, 302, 304 (FIG. 4) for arrival, departure, and en route operations. Sidelights 110, 112, 302, 304 are dual purpose to accommodate necessary requirements for ground and air operations. These sidelights 110, 112, 302, 304 provide position acknowledgement for other aircraft, air traffic controllers, civilians on the ground, and crewmembers. The scope of the sidelights 110, 112, 302, 304 will not be limited to the description of this particular embodiment. The windows 106, 108, 109 permit passengers and crew to acknowledge landmarks outside. The craned air transporter 100 is accessible by the door 206 (FIG. 2). The door 206 is to remain sealed at all times while in operation to prevent injury to the individuals inside or operation failure. The door 206 (FIG. 2) is pushed and pulled manually on this embodiment.

Craned air transporter 100 (FIG. 5) is accessible by the door 504 (FIG. 5) on an extended side of the embodiment. The door 504 has sensors for informing passengers and crew when the door is sealed or not sealed completely. The door 504 (FIG. 5) on this particular embodiment is only operable when all of the conditions are previously met as follows: 1) the craned air transporter 100 is not connected to a craning device by means of mount 114; 2) the craned air transporter 100 is level on a flat surface area; 3) passengers assume no immediate danger outside of the craned air transporter 100. If all precedential conditions are not confirmed with the sensors or individuals inside, then the door 504 will remain locked and sealed.

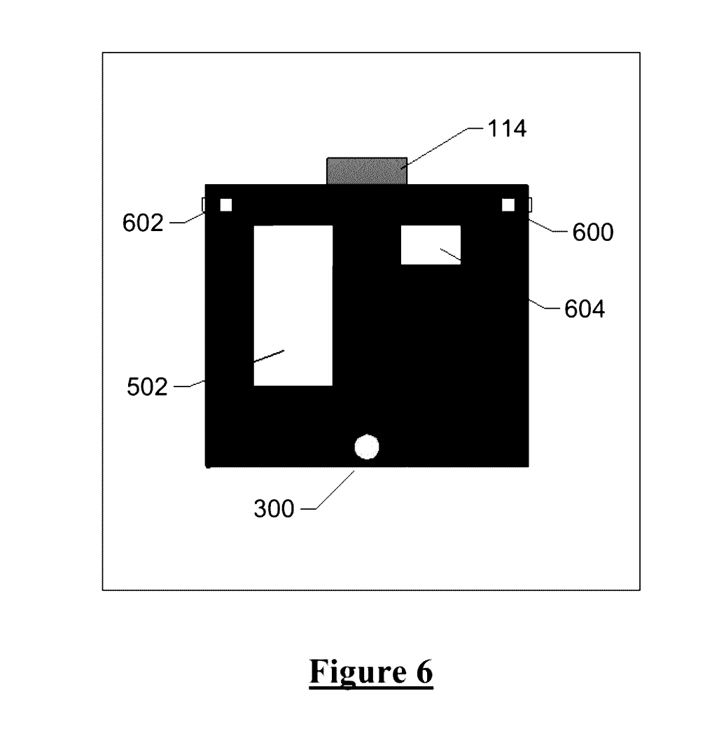

The rear view windows 502, 604 (FIG. 6) are for individuals inside to identify landmarks outside of the embodiment. Window 502 (FIG. 6) differs slightly from the other windows, because it shall be considered an emergency exit. It is designed to permit alternative passage for individuals inside of the embodiment. Window 502 shall meet the requirements for such scenarios confirmed as an emergency situation by the passengers, or for alternative methods. Brackets and pins provide the functionality of an emergency exit on this particular embodiment. Manual interaction is required to achieve the capability of window 502. The scope of window 502 shown in FIG. 6 shall not be limited to the description and operation of this embodiment.

This disclosure specifying any particular assembly, part, operation, best mode, or construction in this disclosure shall no be construed as limitations on the scope of the invention. Rather, they shall cohere with the claims set forth.

What is claimed is:

1. An article of transportation, comprising: a multi-purpose mobile pod assembly means for managing cargo and passenger liabilities with female mount configurations, and producing transitional load and unload functions for all craning operations; and a roof mount, means for securing said article of transportation to a helicopter or crane; a divided base mount, means for securing said article to a separate lock system that is attached to an article of ground transportation; a means conducive to pre-emptive loading for craning operations, whereby said means shall expedite unload and load functions.

2. The article of transportation of claim 1, wherein said multi-purpose mobile pod assembly shall be transitional between ground and air configurations for independent functions with the use of said ceiling mount and divided base mount to secure said pod assembly in the required configuration for each specified operative.

3. The article of transportation of claim 1, wherein said roof mount shall be in female form to receive and secure a craning device, said device shall be attached to a helicopter or crane, and shall secure the dynamic parts from said craning device inside said ceiling mount to permit lifting capabilities.

4. The article of transportation of claim 1, wherein said multi-purpose mobile pod assembly shall have a divided base mount with a female receiver lock area to secure the pod assembly to a powered lock system using a specified approach angle.

5. The article of transportation of claim 1, wherein said multi-purpose mobile pod assembly shall be configured for unload and load functions with regards to all liabilities involved with craning operations, and shall promote a pre-emptive method to maximize safety and expedite the necessary unload and load functions to maximize operational efficiency.

6. The article of transportation of claim 2, wherein said multi-purpose mobile pod assembly mounts are utilized in both ground and air configurations, and shall provide means for independent functions such as drop zone maneuvers and powered lock system protocol for hauling, said mounts shall be interoperable with ground and air devices that are attached to desired machines for effectively executing said independent functions and managing liabilities.

7. The article of transportation of claim 4, wherein said divided base mount shall receive a powered lock system to secure said pod assembly to an article of ground transportation, said powered lock system shall be mechanically designed to mount and secure said pod assembly at a specified approach angle to require no manual interaction for unloading and loading protocol.

8. The article of transportation of claim 6, wherein said ground configurations shall constitute the need for said divided base mount with a female receiver lock area to secure the pod assembly in place for hauling by means of a separate powered lock system that shall insert inside the divided base mount, said powered lock system shall be attached to an article of ground transportation.

9. The article of transportation of claim 6, wherein said air configurations shall constitute the need for a roof mount on top of the pod assembly with a female lock receiver assembly to make a secure connection with a craning device and permit the pod assembly to be lifted with said craning device, said craning device shall insert inside the roof mount to be secured in a lift configuration.

10. A method for managing cargo and passenger liabilities with a multi-purpose mobile pod assembly, comprising: providing said mobile pod assembly means which is operatively constructed with various mounts to execute pre-emptive loading of said liabilities, whereby said means shall expedite departure and arrival operations.
